(19) United States
(12) Patent Application Publication
(10) Pub. No.: US 2022/0236367 A1
(43) Pub. Date: Jul. 28, 2022

(54) LOCATION BASED WIRELESS PET CONTAINMENT SYSTEM USING SINGLE BASE UNIT

(71) Applicant: Radio Systems Corporation, Knoxville, TN (US)

(72) Inventors: Richard Seltzer, Knoxville, TN (US); William Moore, Knoxville, TN (US)

(21) Appl. No.: 17/658,993

(22) Filed: Apr. 12, 2022

Related U.S. Application Data
(63) Continuation-in-part of application No. 17/208,714, filed on Mar. 22, 2021.
Application No. 17/208,714 is a continuation-in-part of application No. 16/715,420, filed on Dec. 16, 2019, now Pat. No. 10,955,521.
Application No. 16/715,420 is a continuation of application No. 16/003,876, filed on Jun. 8, 2018, now Pat. No. 10,514,439.
Application No. 16/003,876 is a continuation-in-part of application No. 17/208,714, filed on Mar. 22, 2021.
(60) Provisional application No. 62/599,248, filed on Dec. 15, 2017.
(60) Provisional application No. 63/078,494, filed on Sep. 15, 2020.

(51) Int. Cl. G01S 5/06; A01K 11/00; A01K 27/00

(52) U.S. Cl. CPC G01S 5/06; G01S 3/46; A01K 27/009; A01K 11/008

(57) ABSTRACT

A device is described herein comprising a base unit including at least three transceivers, wherein the at least three transceivers are communicatively coupled with at least one processor of the base unit. The at least one processor and the at least three transceivers are configured to determine locations of a transceiver remote to the base unit, wherein the location determinations comprise a series of transceiver locations along a boundary path, wherein the series of location determinations define a boundary region. The at least one processor determines locations using information of communications between the transceiver and the at least three transceivers and the relative positioning of the at least three transceivers.

### RELATED APPLICATIONS

This application is a continuation in part application of U.S. application Ser. No. 17/208,714, filed Mar. 22, 2021, which is a continuation in part application of U.S. application Ser. No. 16/715,420, filed Dec. 16, 2019 (now U.S. Pat. No. 10,955,521), which is a continuation application of U.S. application Ser. No. 16/003,876, filed Jun. 8, 2018 (now U.S. Pat. No. 10,514,439), which claims the benefit of U.S. Application No. 62/599,248, filed Dec. 15, 2017.

This application is a continuation in part application of U.S. application Ser. No. 17/208,714, filed Mar. 22, 2021, which claims the benefit of U.S. Application No. 63/078,494, filed Sep. 15, 2020.

### TECHNICAL FIELD

The disclosure herein involves identifying a location of a roaming object in an environment using wireless communications.

### BACKGROUND

Systems and methods have been developed for identifying a location of a roaming object in an environment using wireless communications among multiple base units tracking the object.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 shows a transceiver of a pet collar communicating with base units, under an embodiment.

FIG. 2 shows a method of trilateration, under an embodiment.

FIG. 3 shows a transceiver of a pet collar communicating with base units, under an embodiment.

FIG. 4 shows a method of trilateration, under an embodiment.

FIG. 5 shows a transceiver of a pet collar communicating with base units, under an embodiment.

FIG. 6A shows a transceiver of a pet collar communicating with a single base unit, under an embodiment.

FIG. 6B shows a top down view of a single base unit, under an embodiment FIG. 7 shows components of a single base unit, under an embodiment.

FIG. 8 shows an example of range and angular coordinates, under an embodiment.

FIG. 9 shows a function grid superimposed over a monitored area, under an embodiment.

FIG. 10 shows a transceiver of a pet collar communicating with a single base unit, under an embodiment.

FIG. 11 shows a division of space surrounding a single base unit into quadrants, under an embodiment.

FIG. 12 shows a sample computation of an angular value, under an embodiment.

FIG. 13 shows a sample computation of an angular value, under an embodiment.

FIG. 14 shows a sample computation of an angular value, under an embodiment.

FIG. 15 shows a sample computation of an angular value, under an embodiment.

FIG. 16 shows a configuration of transceivers and antennas in a base unit, under an embodiment.

FIG. 17 shows a configuration of transceivers and antennas, under an embodiment.

FIG. 18 shows a configuration of transceivers and antennas, under an embodiment.

FIG. 19 shows an elevated position of a base unit, under an embodiment.

FIG. 20 shows an elevated position of a base unit, under an embodiment.

FIG. 21 shows a configuration of transceivers and antennas in a base unit, under an embodiment.

FIG. 22 shows a configuration of transceivers and antennas in a base unit, under an embodiment.

FIG. 23 shows a configuration of transceivers and antennas in a base unit, under an embodiment.

FIG. 24 shows a configuration of transceivers and antennas in a base unit, under an embodiment.

FIG. 25 shows a configuration of transceivers and antennas, under an embodiment.

FIG. 26 shows an elevated position of a base unit, under an embodiment.

FIG. 27 shows a configuration of transceivers and antennas, under an embodiment.

FIG. 28 shows an elevated position of a base unit, under an embodiment.

FIG. 29 shows a configuration of transceivers and antennas, under an embodiment.

FIG. 30 shows a configuration of transceivers and antennas, under an embodiment.

FIG. 31 shows a configuration of transceivers and antennas, under an embodiment.

FIG. 32 shows a configuration of transceivers and antennas, under an embodiment.

FIG. 33 shows a configuration of transceivers and antennas, under an embodiment.

FIG. 34 shows a configuration of transceivers and antennas, under an embodiment.

FIG. 35 shows a user holding a collar device during boundary definition, under an embodiment.

FIG. 36A shows a process of boundary definition, under an embodiment.

FIG. 36B shows a boundary, under an embodiment.

FIG. 37A shows a process of boundary definition with an open boundary, under an embodiment.

FIG. 37B shows an open boundary, under an embodiment.

### DETAILED DESCRIPTION

A wireless animal location system is provided that identifies a location of a pet roaming within an environment and tracks/manages animal behavior in the environment using information of pet location. The wireless pet location system (or containment system) may disallow access to an area within an environment by applying a negative stimulus when an animal enters a prohibited location. For example, the system may apply a negative stimulus when an animal approaches a pantry space or waste collection space. Conversely, the system may allow the animal free and unimpeded access to other portions of the environment. For example, the system may forgo adverse stimulus when the animal is in desired locations such as animal bedding areas or dedicated animal play areas. The system may simply log an event in order to compile information regarding the animal's behavior. For example, the system may detect and log the presence of the animal near a watering bowl. Further the system may report such information to mobile applications allowing pet owners to monitor and track animal behavior in a home.

An RF-based wireless pet location system may utilize signal strength, two way ranging techniques, and/or time difference of arrival (techniques) to locate a target.

A signal strength based approach uses Received Signal Strength Indicator (RSSI) values to determine the range between a roaming target and three or more spatially separated base units. The target or animal may wear a transceiver housed within a collar. The transceiver may receive and send RF signals to base units. Under an embodiment, three base units within the target's environment periodically transmit RF signals. The pet transceiver estimates its distance from each base unit using the strength of the corresponding RF communication received from each of the base units, i.e. using RSSI values. Based on the multiple ranging measurements, and a known location of the base units within a grid system, a single location may be resolved within the grid system.

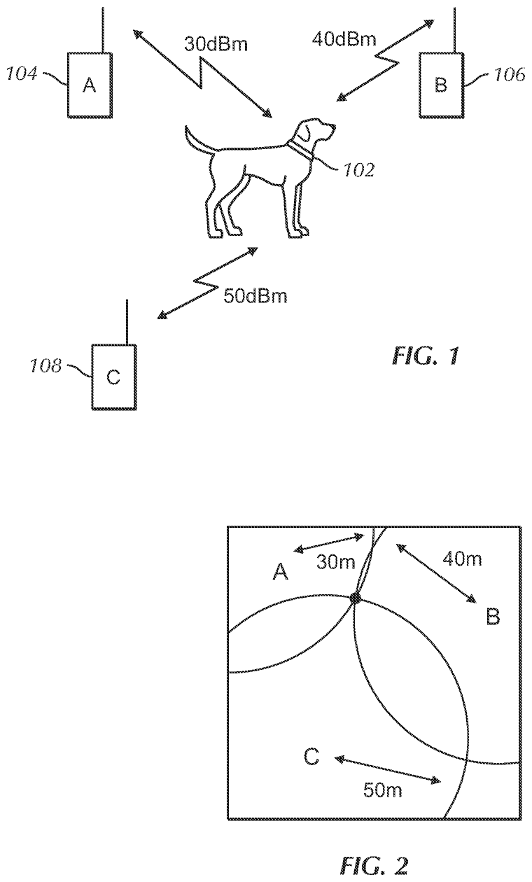

FIG. 1 shows an animal worn transceiver 102 in range of three transmitting base units 104, 106, 108. The transceiver 102 communicates with base unit 104, base unit 106, and base unit 108. Based on measured RSSI values, the animal worn collar determines an approximate range from pet to base 104 (−30 dBm, 30 meters), from pet to base 106 (−40 dBm, 40 meters), and from pet to base 108 (−50 dBm, 50 meters). FIG. 2 shows a trilateration method which uses information of the three radii (i.e., distances from transceiver to base units) to identify the location of the pet as a point of intersection between three circles. In other words, base units 104, 106, 108 become center points A, B, C of circles with respective radii of 30 m, 40 m, and 50 m. Since locations of the base units are known within a grid system, the circles intersect at a grid location corresponding to the pet transceiver location. The grid system is established and linked to absolute positions at time of system set-up.

This system requires at least three base units. This complicates the system as an outdoor installation needs to power any unit that is remote to an AC power source. This likely requires that one or more of the base units operate on underground wires or DC power, which is inconvenient if rechargeable, or expensive if primary cells are used. Also, the inclusion of three base units greatly increases the cost of a system. Further, the resultant location is not precise due to the variation of each signal strength determination due to environmental conditions and antenna pattern variation.

A wireless animal location system may use two way ranging (TWR) to determine and monitor animal location under an embodiment. The system may comprise a transceiver housed by a collar worn by an animal and three or more base units distributed in the monitored environment. The system determines the range between the animal target (i.e., animal collar) and the three or more spatially separated base units based on TWR of an RF signal between the target and each of the base units. Based on the multiple time of flight measurements between the collar transceiver and known locations of the base units within a grid system, a single location may be resolved within the grid system.

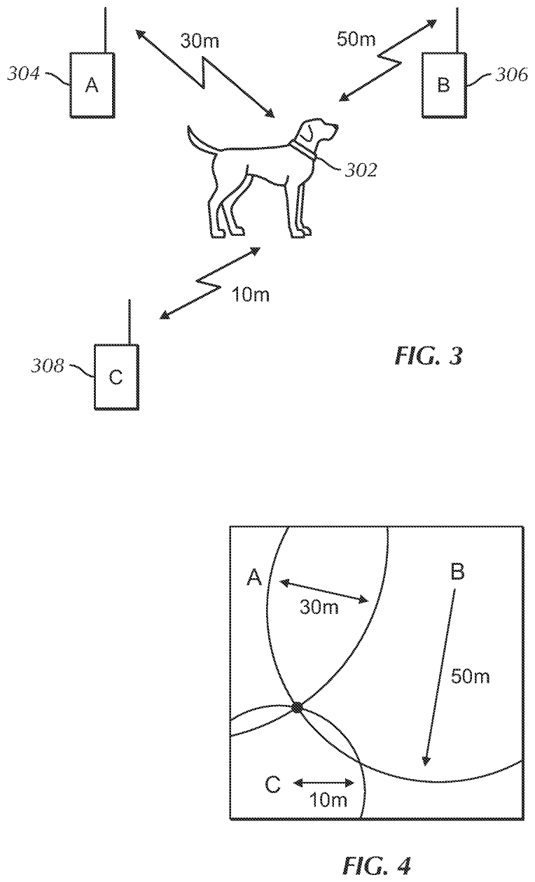

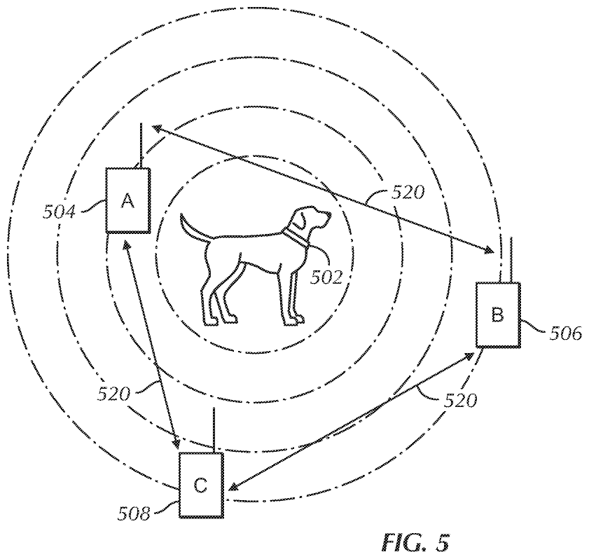

FIG. 3 shows an animal worn transceiver 302 in range of three transmitting base units 304, 306, 308. The pet transceiver 302 communicates with base unit 304, base unit 306, and base unit 308. During each two way communication, the pet transceiver uses time of flight to determine a range to each base unit. For example. the pet transceiver sends a communication at time t=t₀=0. A base unit may process the communication and send a return communication at time t=t₁. The pet transceiver (i.e. pet collar) receives the return communication and records the receipt of the communication's first pulse at time t=t₂. The time of flight is then computed as (t₂—processing time)/2. This time of flight corresponds to a distance. Based on such time of flight calculations, the animal worn collar determines an approximate range from pet to base 304 (30 meters), from pet to base 306 (50 meters), and from pet to base 308 (10 meters). FIG. 4 shows a trilateration method which uses information of the three radii (i.e., distances from transceiver to base units) to identify the location of the pet as a point of intersection between three circles. In other words, base units 304, 306, 308 become center points A, B, C of circles with respective radii of 30 m, 50 m, and 10 m. Since locations of the base units are known within a grid system, the circles intersect at a grid location corresponding to the pet transceiver location.

The system described above requires at least three base units. This complicates the system as an outdoor installation needs to power any unit that is remote to an AC power source. This likely requires that one or more of the base units operate on underground wires or DC power, which is inconvenient if rechargeable, or expensive if primary cells are used. Also, the inclusion of three base units greatly increases the cost of a system.

A wireless animal location system may use time difference of arrival calculations under an embodiment. FIG. 5 shows an animal worn transceiver 502 in range of three transmitting base units 504, 506, 508. The base units 504, 506, 508 communicate 520 with each other to synchronize their respective clocks. The pet collar transceiver 502 periodically transmits RF signals. A pet collar RF transmission is received by base units 504, 506, 508. Upon reception, each base unit time stamps the received signal data. Based on the received times, a location of the pet transceiver may be resolved. Typically, the resolved location is calculated in one of the base units or a remote computer and then communicated to the animal worn transceiver as the animal worn transceiver is typically battery powered and energy conservation is a concern.

The time differential information may be used to determine the difference in distances between the target transceiver 502 and base units 504, 506, 508. The difference in distance information may then be used to determine hyperbolas representing possible locations of the transceiver. The intersection of hyperbolas is then used to locate the pet transceiver in a grid system.

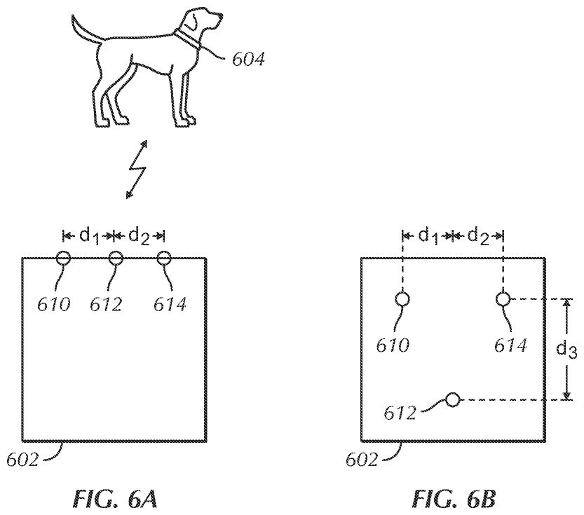

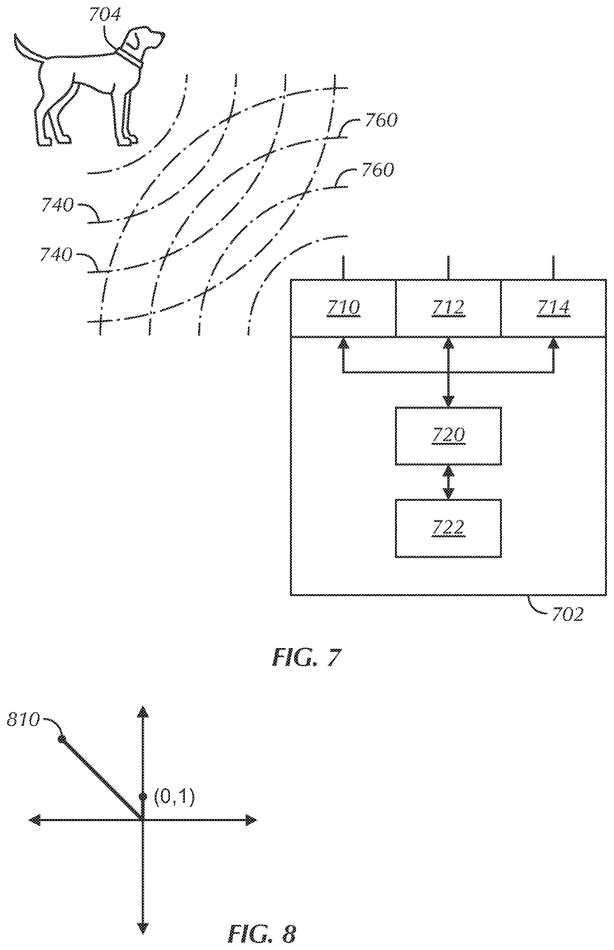

FIG. 6A shows a base unit 602 and an animal worn collar housing a transceiver 604. The base unit comprises antennas 610, 612, 614. FIG. 6B displays a top down view of the base unit. FIGS. 6A & 6B together disclose that the distance between antenna 610 and antenna 614 is d₁+d₂. The altitude of the triangle (formed by the antennas) extending from antenna 612 is d₃. The distance d₁ may be equal to distance d₂ but embodiments are not so limited. Each antenna may be connected or coupled with a transceiver for sending and receiving RF communications or with a receiver for receiving communications.

FIG. 7 shows a stylized side view of the base unit 702 communicating with a pet transceiver 704 housed by a pet collar. The base unit couples transceiver/antenna 710, receiver/antenna 712, and receiver/antenna 714 with a processing unit 720 which is further connected/coupled to memory 722. The processing unit clocks incoming and/or outgoing communications and synchronizes the transceiver/receivers 710, 712, 714. The base unit emits an RF signal communication 740 using antenna/transceiver 710. The pet transceiver 704 processes the communication and sends a return communication 760. Each antenna unit 710, 712, 714 receives the return communication. The base unit may use two way ranging and the time differential of the return communication received at each transceiver/receiver to resolve a range and angular reference for locating the pet transceiver.

FIG. 8 shows an example of range and angular reference location. FIG. 8 shows an x-y Cartesian coordinate system. The point 810 is located 22 meters from (0,0) and is offset from unit vector (0,1) by 310 degrees (when the angular degree value represents a clockwise rotation of 310 degrees). The range and angular coordinates are then expressed as (22 m, 310 degrees). This coordinate system may be more formally described as a polar coordinate system. A polar coordinate system is a two-dimensional coordinate system in which each point on a plane is determined by a distance from a reference point, i.e. range value, and an angle from a reference direction, i.e. an angular value. The range and angular information may be mapped into Cartesian coordinates as follows:

$$x = 22 * cos ( 14 {0}^{∘} ) = - 16.85$$

$$y = 22 * sin ( 14 {0}^{∘} ) = 14.14$$

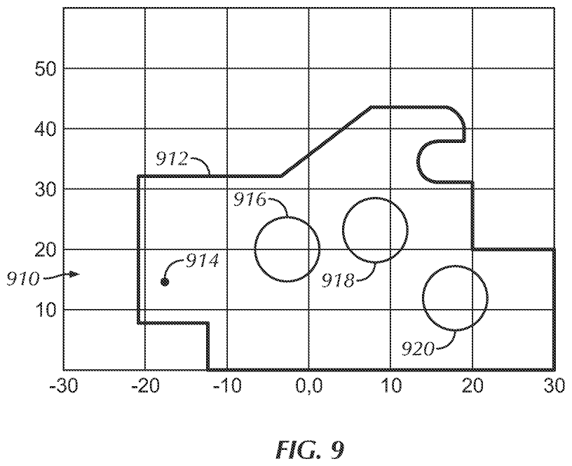

FIG. 9 shows a grid superimposed over the monitored area. Each square in the grid corresponds to a set of (range, angular) locations or (x,y) coordinates. Each grid square and corresponding (range, angular) locations may be assigned particular functions. Of course, grid assignments are not restricted to square or rectangular areas. Grid assignments may be assigned to grid portions (i.e. circular, elliptical, manually defined, etc.) and corresponding (range, angular) or (x,y) coordinates.

A grid portion or collection of grid portions may comprise a correction region (i.e. stimulus applied to pet in such region), a keep out region, a containment area, or a notification area. A base unit may transmit appropriate commands to the pet collar when the base unit locates the collar in corresponding grid portions. For example, the base unit may instruct the collar to apply a negative stimulus when the animal is in location 910. The base unit may instruct the collar take no action (or otherwise provide no instruction to take any action) when the animal is at location 914 within containment area 912. The base unit may instruct the collar to apply a negative stimulus when the animal is within a keep out region 916. The base unit may instruct the collar to log the location of the animal when the animal is within location areas 918, 920. Note that a keep out region or a notification region may be assigned to locations within a region that is a general containment area and in which no instruction is generally provided to the animal. This is possible due to the fact that specific areas within the monitored environment may be specifically associated with a function. In this way monitored environment areas 910 and 916 map to a corrective function and monitored environment areas 918, 920 map to logging/notification functions. Under an embodiment, a containment area may simply be all areas in the monitored environment not assigned a correction function.

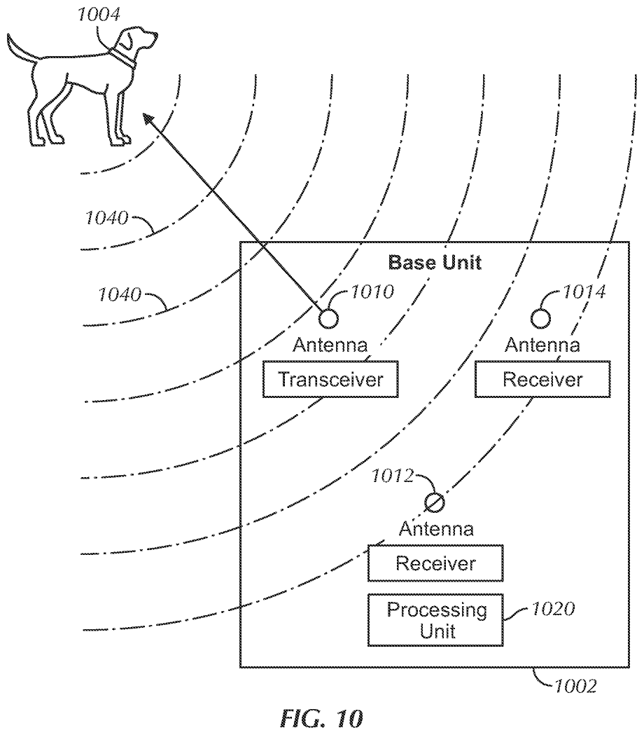

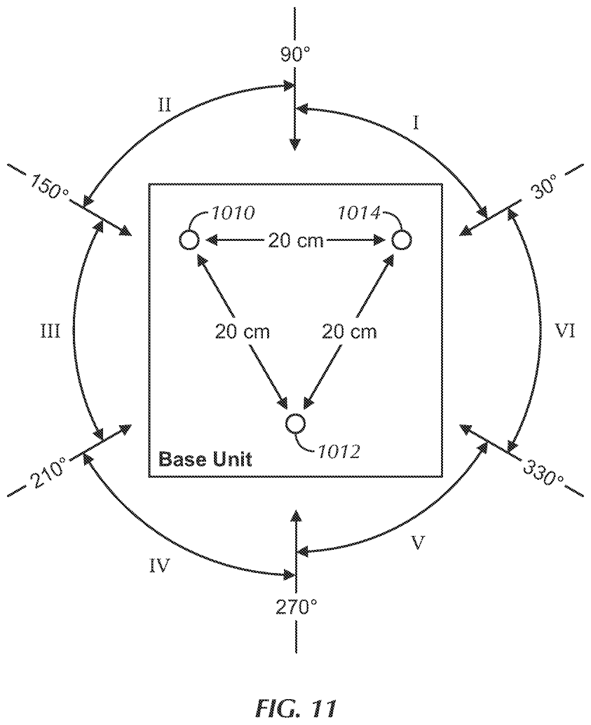

FIG. 10 shows a top down view of a base unit 1002 communicating with a pet transceiver 1004 housed by a pet collar. The base unit couples transceiver/antenna 1010, receiver/antenna 1012, and receiver/antenna 1014 with a processing unit 1020 which is further connected or coupled to memory (as shown in FIG. 7). The transceiver/antenna 1010, receiver/antenna 1012, and receiver/antenna 1014 may form vertices of an equilateral triangle with sides of 20 cm under one embodiment. The processing unit clocks incoming and/or outgoing communications and synchronizes the transceiver/receivers 1010, 1012, 1014. The base unit emits an RF signal communication (not represented in FIG. 10) using antenna/transceiver 1010. The pet transceiver processes the communication and sends a return communication 1040. Each antenna unit receives the return communication. As further described below, the base unit may use time of flight information received and processed through antenna/transceiver 1010 and time differential of the return communication received at each base unit antenna to resolve a range and angular reference for locating the pet transceiver. A detailed example of this method is provided below.

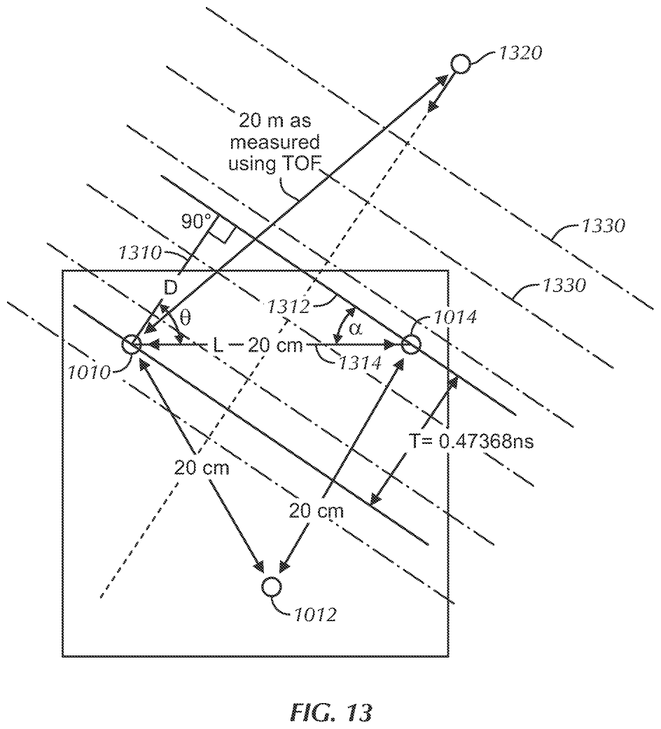

The transceiver/antenna 1010 transmits an RF message or communication at time 0 seconds. The pet transceiver receives the first pulse of the communication at 66.7128 ns. The pet transceiver then processes the message and develops a response. The pet transceiver transmits the response at 1000 ns. The base unit transceiver/antenna 1010 receives the first pulse of the communication at 1066.7128 ns. The base unit receiver/antenna 1014 receives the first pulse of the communication at 1067.18648 ns. The base unit receiver/antenna 1012 receives the first pulse of the communication at 1067.3572 ns. Note that the data disclosed in this paragraph corresponds to the example set forth below with respect to FIG. 13.

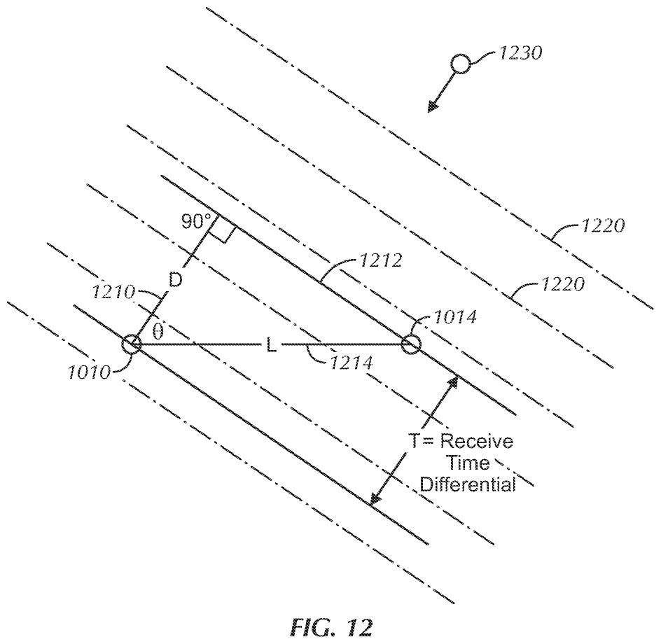

This process collects key information for resolution of a range and angular value for locating the pet transceiver. First, the process reveals the order in which base unit antennas 1010, 1012, 1014 receive the return transmission from the pet transceiver. Second, the process reveals a return time differential between base unit antennas. Continuing with the example set forth above the receive time differential between transceiver/antenna 1010 and receiver/antenna 1014 is 0.47368 ns. Third, the process provides range information. The time of flight between transmission of the response communication and receipt thereof by transceiver/antenna 1010 with respect to the example set forth above comprises 66.7128 ns corresponding to a distance of 20 meters from transceiver/antenna 1010 to pet transceiver. This information may be used to determine range and angular values for locating the pet using a far field model as further described below. Again note that the data disclosed in this paragraph corresponds to the example set forth below with respect to FIG. 13. In addition, the antennas 1010, 1012, 1014 form an equilateral triangles with sides of 20 cm with respect to all of the examples set forth below (see FIGS. 12-14 and corresponding examples).

Under one embodiment, a far field model may determine range and angular values using two way ranging and time difference of arrival computations set forth above. The far field model is based on the fact that the distance from base unit to pet transceiver is significantly farther than the distance between transceiver/receivers of the base unit. This model allows a spherical wave to be approximated by a plane.

The far field model implements the following steps:

Use time of flight information to determine a distance from transceiver/antenna to pet transceiver.

Determine the first two antennas to receive a return transmission from a pet transceiver.

Use the information of the first two receiving antennas to determine an approximate “quadrant” region surrounding the pet (as further shown in FIG. 11 below).

Determine a time difference of arrival between the two first antennas.

Use equations based on an identified region (see FIG. 11 below) to determine angular information. The examples set forth below adopt the base unit configuration of FIG. 10. Further, the examples set forth below assume that the line between antenna 1010 and 1014 represents the reference line for angular values. It is further noted that angular values (in the examples provided below) extend from the reference line in a counter clockwise direction.

FIG. 11 shows an example of quadrant determination based on the time of arrival among antennas. The example shown in FIG. 11 is based on an implementation utilizing a base unit consisting of three transceiver/receivers positioned as an equilateral triangle, although the number and position of transceiver/receivers are not limited to these arrangements. FIG. 11 shows Quadrants I-VI and corresponding order of reception among antennas:

Quadrant 1 (30-90 degrees): first reception 1014, second reception 1010

Quadrant II (90-150 degrees): first reception 1010, second reception 1014

Quadrant III (150-210 degrees): first reception 1010, second reception 1012

Quadrant IV (210-270 degrees): first reception 1012, second reception 1010

Quadrant V (270-330 degrees): first reception 1012, second reception 1014

Quadrant VI (330-30 degrees): first reception 1014, second reception 1012

As demonstrated by the partitioning of planar space in FIG. 11, order of reception limits the location of the pet transceiver to a particular quadrant or angular region.

FIG. 12 shows a computation of an angular value with respect to a pet location. FIG. 12 show a return RF transmission 1220 from a pet transceiver 1230 located in quadrant I. This is known due to first reception at antenna 1014 and second reception at antenna 1010. Under the far field model, antenna 1010 and 1014 are vertices of a triangle with side 1210 oriented in the general direction of the pet transceiver. The far field model approximates the angle between side 1210 and side 1212 as a ninety (90) degree angle. Again this is possible because the distance between antennas is significantly less than the distance between antennas and pet transceiver. The length L of the line 1214 between antenna 1010 and antenna 1014 is known at 20 cm. FIG. 12 shows the angle θ between lines 1210 and 1214. The length of side 1210 (i.e., the value of D as shown in FIG. 12) may then be computed as follows:

D=CT

C=speed of RF signal from pet transceiver

T=receive time differential between antennas 1010, 1014

Once D is known, there is enough information to solve for 0 (as described in greater detail below) and thereby determine an angular value.

FIG. 13 shows an example of a base unit receiving a transmission 1330 from pet transceiver 1320 in Quadrant I. This is known due to first reception at antenna 1014 and second reception at antenna 1010. The time of flight and corresponding distance between antenna 1010 and pet transceiver 1320 is 66.7128 ns and 20 m. Antenna 1010 and 1014 form vertices of a triangle with side 1310 oriented in the general direction of the pet transceiver. The angle between sides 1310 and 1312 is approximated as 90 degrees under the far field model. The length of side 1314 is known at 20 cm. The time differential between antennas 1010 and 1014 is 0.47368 ns. The length D of side 1310 may now be computed. Further, the value of 0 may be calculated by first computing the value of α as follows:

$$α = {sin}^{- 1} ( \frac{C T}{L} ) = {sin}^{- 1} [ \frac{( \frac{30 cm}{ns} ) * ( . 4 \; 7368 ns )}{20 cm} ] = {sin}^{- 1} [ .71052 ]$$

$$α = 45.27 {8}^{∘} \\ θ = 18 {0}^{∘} - 9 {0}^{∘} - 45.27 {8}^{∘} = 44.72 {3}^{∘}$$

Therefore the location of the pet may be approximate with a range, angular value of (20 m, 44.723).

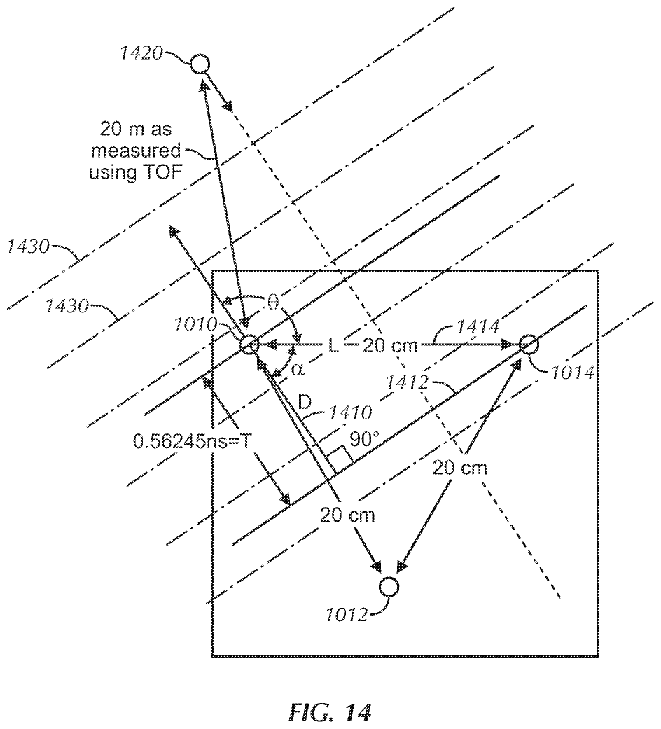

FIG. 14 shows an example of a base unit receiving a transmission 1430 from pet transceiver 1420 in Quadrant II. This is known due to first reception at antenna 1010 and second reception at antenna 1014. It is assumed the time of flight between pet transceiver 1420 and antenna 1010 indicates a distance of 20 m. Antenna 1010 and 1014 form vertices of a triangle with side 1410 oriented in the general direction of the pet transceiver. The angle between sides 1410 and 1412 is approximated as 90 degrees under the far field model. The length of side 1414 is known at 20 cm. The time differential between antennas 1010 and 1014 is 0.56245 ns. The length D of side 1410 may now be computed. The value of 0 may be calculated by first computing the value of a as follows:

$$α = {cos}^{- 1} ( \frac{C T}{L} ) = {cos}^{- 1} [ \frac{( \frac{30 cm}{ns} ) * ( . 5 \; 6245 ns )}{20 cm} ] = 32.4 {7}^{∘}$$

$$α = 32.4 {7}^{∘}$$

$$θ = 18 {0}^{∘} - α = 18 {0}^{∘} - 32.4 {7}^{∘} = 147.5 {3}^{∘}$$

Therefore, the location of the pet may be approximated with a range, angular value of (20 m, 147.53).

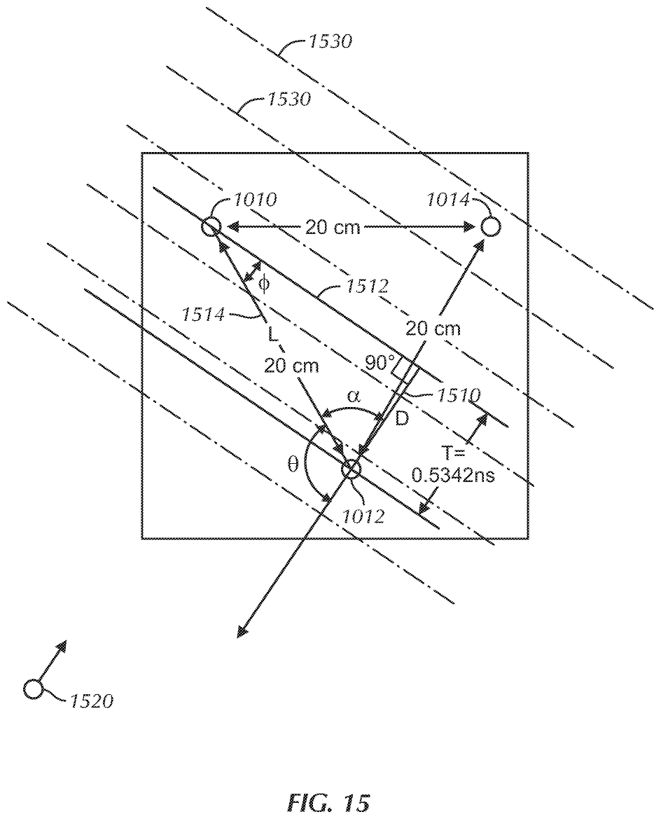

FIG. 15 shows an example of a base unit receiving a transmission 1530 from pet transceiver 1520 in Quadrant III. This is known due to first reception at antenna 1012 and second reception at antenna 1010. It is assumed the time of flight between pet transceiver 1520 and antenna 1012 indicates a distance of 20 m. Antenna 1010 and 1012 form vertices of a triangle with side 1510 oriented in the general direction of the pet transceiver. The angle between sides 1510 and 1512 is approximated as 90 degrees under the far field model. The length of side 1514 is known at 20 cm. The time differential between antennas 1010 and 1012 is 0.5342 ns. The length D of side 1510 may now be computed. Further, the value of θ may be calculated by first computing the value of Ø and α as follows:

$$∅ = {sin}^{- 1} ( \frac{C T}{L} ) = {sin}^{- 1} [ \frac{( \frac{30 cm}{ns} ) * ( . 5 \; 342 ns )}{20 cm} ] = {sin}^{- 1} [ .8013 ] = 53.2 {5}^{∘}$$

$$α = 18 {0}^{∘} - 9 {0}^{∘} - 53.2 {5}^{∘} = 36.7 {5}^{∘} \\ θ = 18 {0}^{∘} - 36.7 {5}^{∘} = 143.2 {5}^{∘}$$

Therefore, the location of the pet may be approximated with a range, angular value of (20 m, 263.25). In this case, it is known based on time differential that the pet transceiver is located in Quadrant III. This means that θ is computed with respect to antennas 1010 and 1012. Therefore, the angular value must be approximated by adding 120° such that the angular value sweeps through Quadrant I and Quadrant II and then an additional 143.25° through Quadrant III. In like manner, angular estimates for the pet transceiver in quadrants IV, V, and VI should add 180°, 240°, and 300°, respectively.

It should be further noted that angle computations are applied according the detected position of the pet transceiver. As indicated above, it is known based on receive time differentials that the pet transceiver is located in one of Quadrants I-VI. As one example, the pet transceiver may be located in Quadrant V. Therefore, a known computation may be applied to determine an angular location of the animal with respect to a line between antennas 1012 and 1014. Assuming the facts set forth above with respect to FIGS. 12-16, an additional 240 degrees is then added to the angular estimate. The pet transceiver is then located at the adjusted angular estimate (with respect to the line between antennas 1010 and 1014, i.e. the zero angular reference) and approximately 20 meters from the base unit.

The examples presented above utilize three antennas in an equilateral triangle configuration, however this is not a limitation as the number of antennas can be any number greater than three, or greater than two if a physical limitation exists to block 180 degrees of the coverage of the area. Further, the configuration of antennas is not limited to any specific trigonometric configuration.

It should be noted that the time difference of arrival among transceiver/antennas and/or receiver/antennas may be determined by the difference in phase of the carrier signal of an incoming signal.

Three dimensional positional resolution can also be performed. It can be treated as two separate two-dimensional position resolutions in two perpendicular planes as long as there are positional differences between the antennas in the two planes.

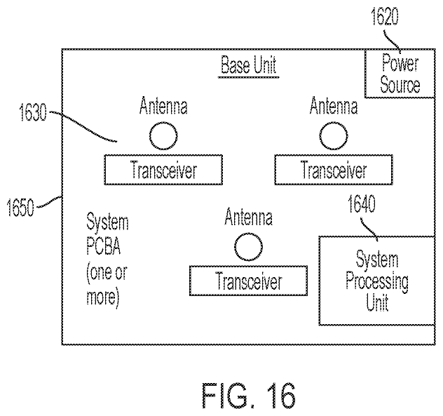

A single base station wireless animal location system as described above determines the distance and bearing angle relative from a reference axis originating at the base station and a target animal wearing a transceiver that is communicatively coupled with the base station. The base station contains at least one transceiver and two receivers. These receivers can also be realized as transceivers. The embodiments below simply refer to transceiver arrays. Each of these transceivers has an associated antenna. The base station also includes a system processing unit. The system processing unit is linked to the transceivers via analog or digital cabling. This linking typically occurs within a system Printed Circuit Board Assembly (PCBA). There must also be some sort of power source, whether that be power from an external source cabled into the system or a local battery pack. Power is routed from the power source to the system processing unit and transceivers. FIG. 16 shows a base unit comprising PCBA 1650, transceivers/antennas 1630, system processing unit 1640, and power source 1620. The PCBA provides connectivity from system processing unit to transceivers and receivers. The PCBA provides power distribution from the power source to the system processing unit and transceivers. The distance between the transceivers/antennas is under one embodiment 20 cm as shown in FIG. 11.

To measure the distance from the base station to the target animal wearing a communicatively coupled transceiver, the system utilizes time-of-flight of an RF signal as described in detail above. One of the transceivers on the base unit is responsible for communicating with the animal transceiver via RF signals. During this exchange, the time of flight of an RF signal from a transceiver antenna on the animal to the location of the base unit transceiver antenna may be determined. The time of flight is then converted into a distance.

To determine the bearing relative to a reference axis to the transceiver on the animal, the difference in RF communication time between the transceivers contained within the base unit and the transceiver on the animal must be determined. As already described in detail above, this delta time can be measured as a time difference or a phase difference. Once the difference in times between the transceivers are known, a direction to the target can be calculated.

To make this all work, the transceiver antennas within the base unit must have first-path RF communication with the transceiver on the animal. If this first-path is blocked and a reflection is utilized, the additional path distance the reflected signal took will be utilized, corrupting the range and relative bearing calculations.

A single base station wireless animal location system depends on reliable RF communication between the multiple transceivers contained within the base unit and the transceiver located on the target animal.

As the transceivers within the base unit need to communicate with a system processing unit, these transceivers are typically mounted on one or more Printed Circuit Board Assemblies (PCBAs). These PCBAs typically contain conductive traces and ground planes. The PCBA provides connectivity from the system processing unit to the transceivers. The PCBA also provides power distribution from the power source to the system processing unit and transceivers.

The problem is that the RF signals sent to, and received from, the target animal transceiver can be blocked by the conductive components of this PCBA. The impact of the blockage is a degradation in the accuracy of the resulting position. This can manifest itself in the lack of an ability to retrieve a position, or even worse, a false position report. A false position report can lead to a false “correction” being applied to an animal within a wireless containment system. If the area of obstruction is near a boundary, it could even allow an animal to escape the containment system, endangering the animal's wellbeing.

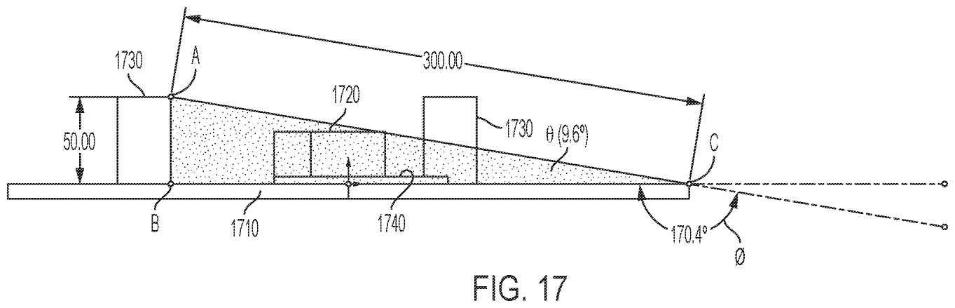

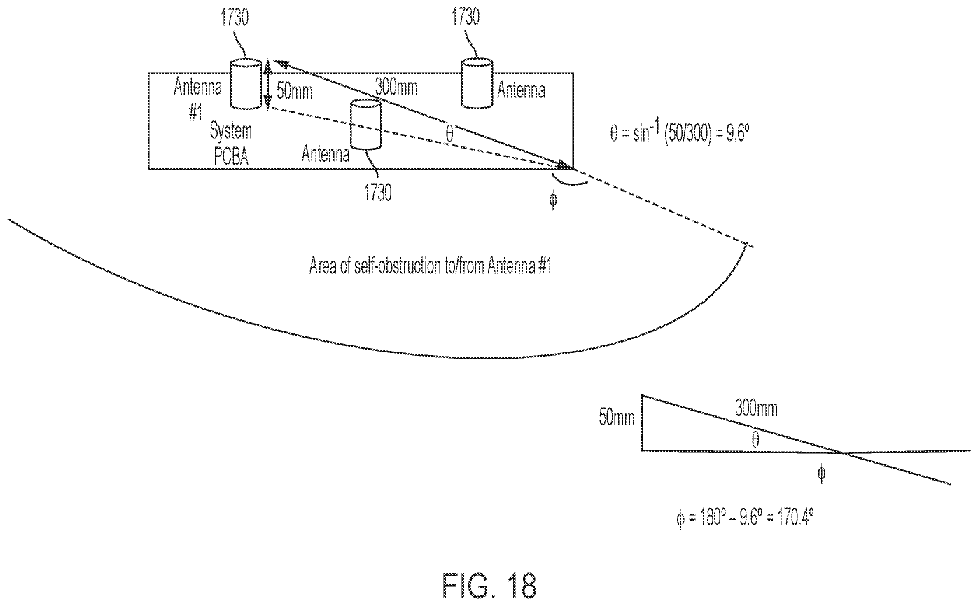

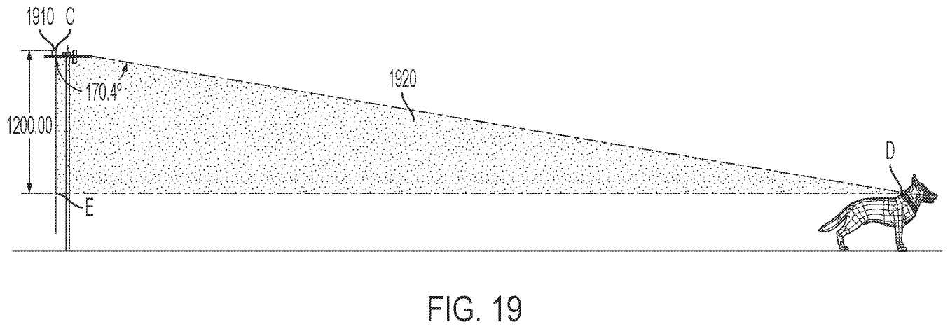

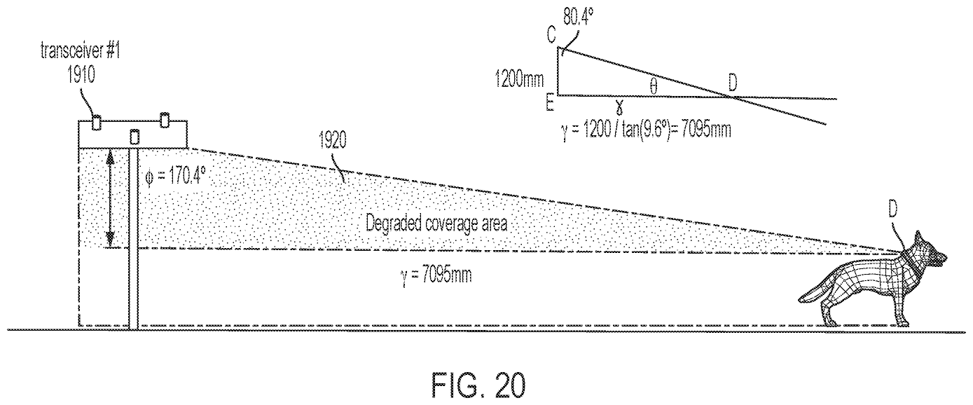

FIG. 17 and FIG. 18 show a three transceiver/antenna array 1730 (with one transceiver, antenna not visible in FIG. 17), PCBA 1710, system processing unit 1740, and power source 1720. The antennas sit on the PCBA with a height of 50 mm. The angle θ of triangle ABC is computed at θ=sin⁻¹ 50/300=9.6. The angle of obstruction is then calculated as ϕ=180−9.6=170.4. FIGS. 19 and 20 show triangle ECD. Line ED comprises a line parallel with ground and intersecting animal transceiver at point D. Line EC connects point E and point C (which is the top of transceiver 1). Note that angle ECD is 80.4 degrees. Note that the base unit is mounted in an elevated position such that transceiver 1910 is positioned 1,200 mm above the collar transceiver height. Accordingly, distance γ is computed as γ=1200/_{tan 9.6}=7095 mm. Based on these calculations, FIGS. 19 and 20 show the degraded coverage areas 1920.

Various transceiver/antenna placement configurations are described below and are each designed to mitigate RF blockage. The transceivers/antennas in the examples below are positioned 20 cm from each other in a manner similar to the configuration shown in FIG. 11 but embodiments are not so limited.

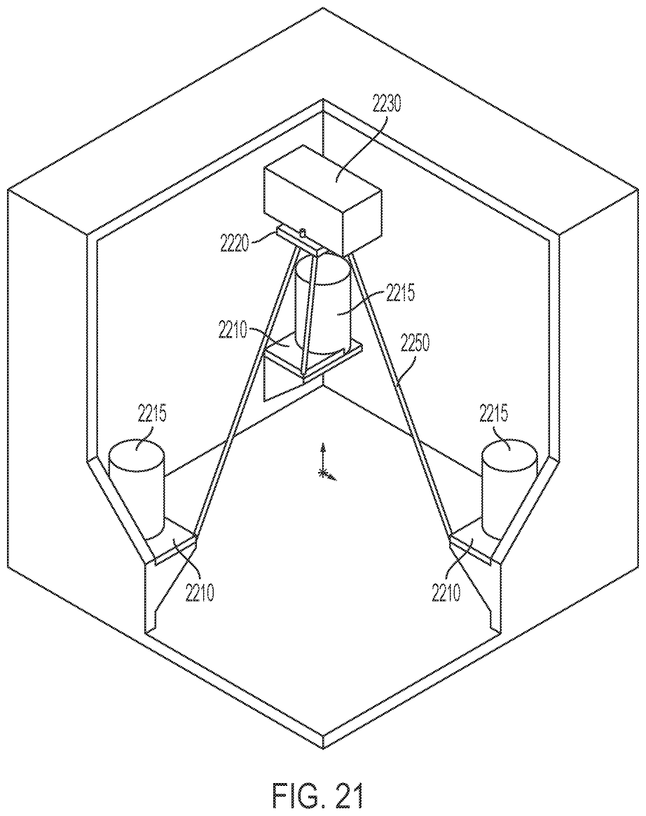

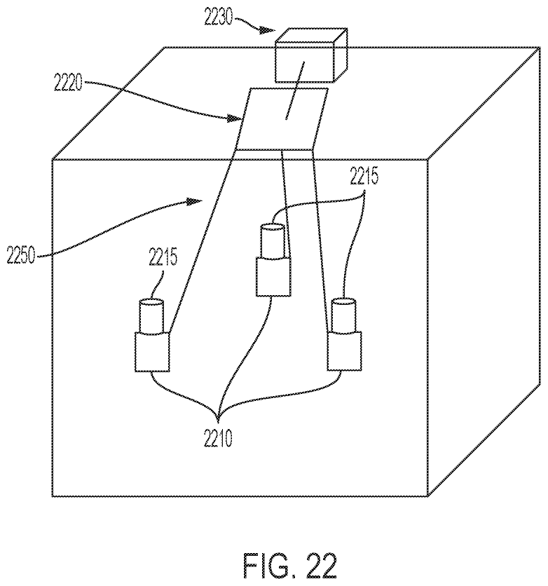

FIGS. 21 and 22 show antennas 2215 within the base unit mounted on small individual PCBAs 2210 captured by the enclosure. Each transceiver/antenna/PCBA mount is connected to a system processing unit PCBA 2220 and power source 2230 with cables. The system processing unit PCBA 2220 is mounted above the transceivers.

Each transceiver/antenna is mounted on a small PCBA The PCBA comprising the system processing unit (SPU) is located above transceiver PCBAs. The system processing unit PCBA is held in place within a low dielectric loss factor enclosure (likely a plastic) by a material with a low dielectric loss factor. The SPU communicates with the transceivers via cables. These cables also distribute power throughout the base unit. The precise positioning of the transceivers within the base unit are critical to the calculations of the positional determination of the pet transceiver. To accomplish this requirement, the transceivers are precisely captured within the low dielectric loss factor enclosure by a material with a low dielectric loss factor. This approach allows the RF energy to pass relatively unimpeded between the transceivers within the base unit to the transceiver on the pet.

If the implementation is powered by mains power, the power cables can enter the enclosure from the top or bottom. If the implementation is battery powered, the power source could be mounted on the top of the enclosure above the SPU PCBA.

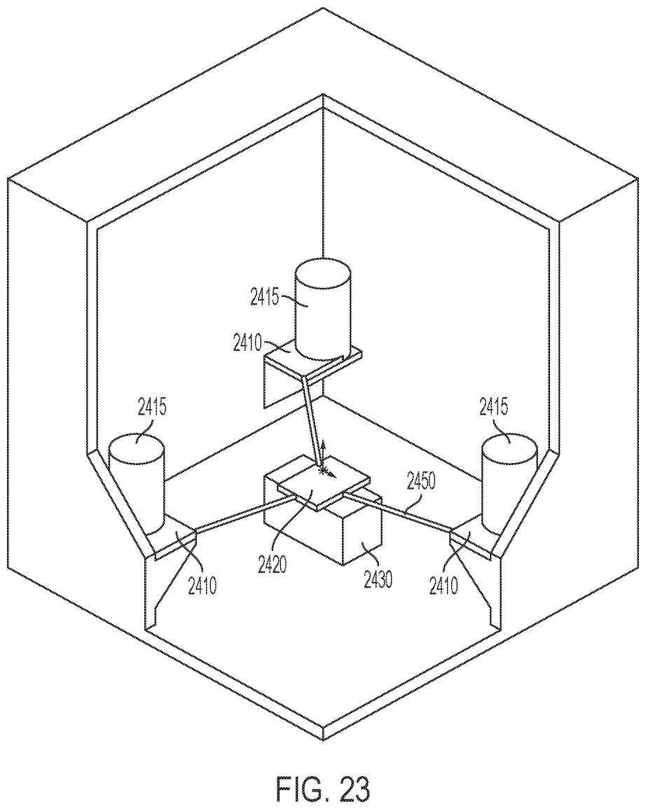

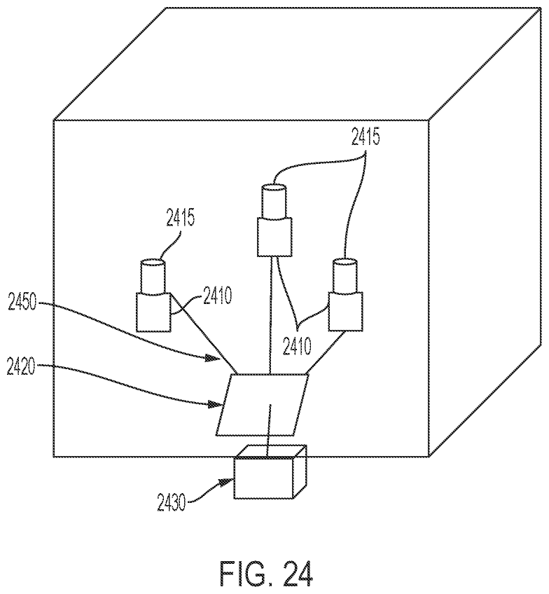

FIGS. 23 and 24 show antennas 2415 within the base unit mounted on small individual PCBAs 2410 captured by the enclosure. Each transceiver/antenna/PCBA mount is connected to a system processing unit PCBA 2420 and power source 2430 with cables 2450. The system processing unit PCBA 2420 is mounted below the transceivers.

Each transceiver/antenna is mounted on a small PCBA. The PCBA comprising the system processing unit (SPU) is located below transceiver PCBAs. The system processing unit PCBA is held in place within a low dielectric loss factor enclosure (likely a plastic) by a material with a low dielectric loss factor. The SPU communicates with the transceivers via cables. These cables also distribute power throughout the base unit. The precise positioning of the transceivers within the base unit are critical to the calculations of the positional determination of the pet transceiver. To accomplish this requirement, the transceivers are precisely captured within the low dielectric loss factor enclosure by a material with a low dielectric loss factor. This approach allows the RF energy to pass unimpeded between the transceivers within the base unit to the transceiver on the pet.

If the implementation is powered by mains power, the power cables can enter the enclosure from the top or bottom. If the implementation is battery powered, the power source could be mounted on the top of the enclosure above the SPU PCBA.

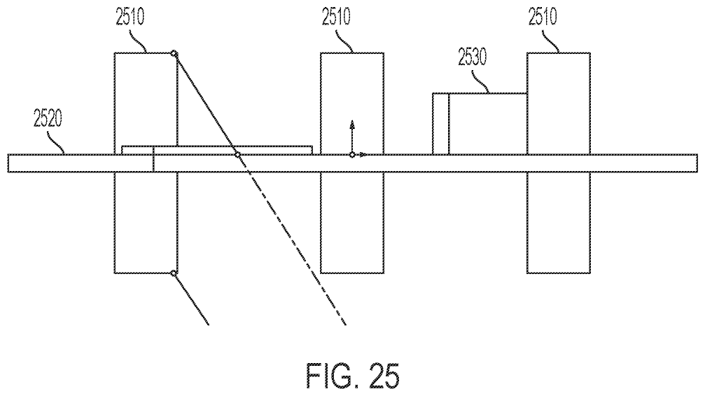

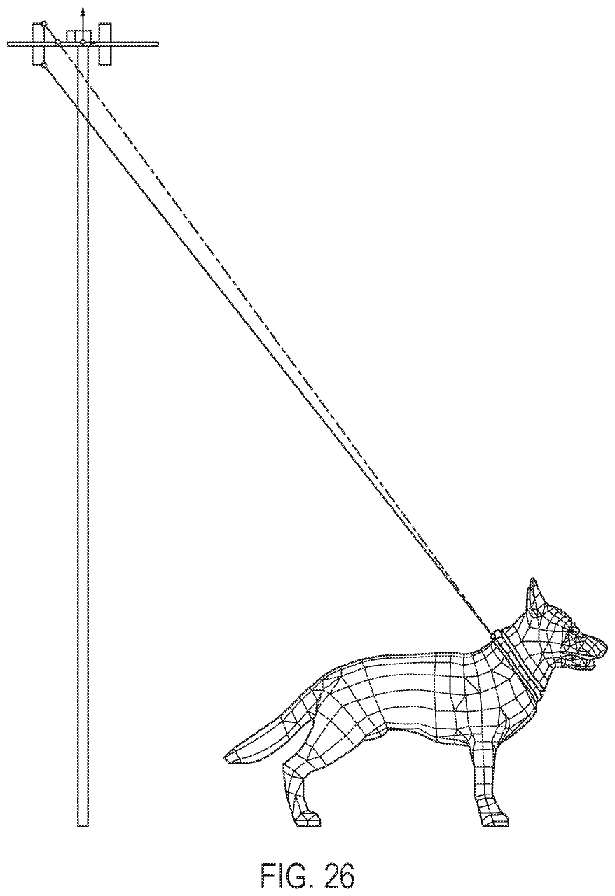

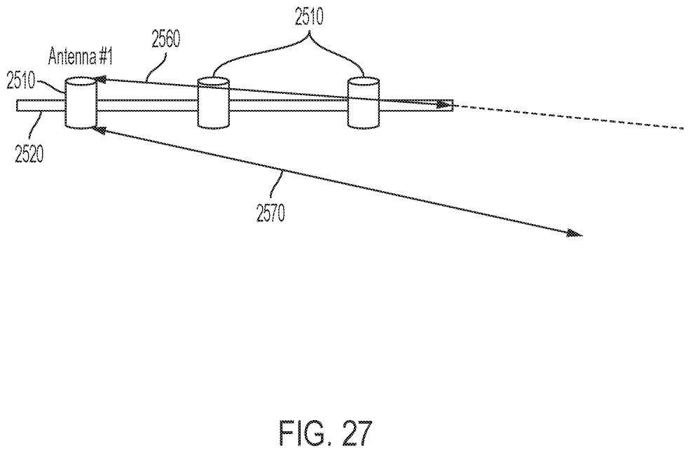

FIGS. 25-27 show transceiver antennas 2510 that extend above and below the system processing unit (SPU) PCBA 2520. FIGS. 25-27 also show power source 2530. The transceiver antennas extend above and below the system PCBA. Any base unit transceiver to pet transceiver RF path 2560 that is blocked by the PCBA has a second path 2570 on the opposite side of the PCBA that would not be blocked. The antenna extension to the second side of the PCBA may be accomplished with a single array of antennas that extend above and below the PCBA or separate array of antennas on each side of the SPU PCBA. FIGS. 25-27 demonstrate the RF path blockage between the animal and transceiver antenna. It is demonstrated that the extension of the blocked antenna below the PCBA provides a direct RF path to the animal. With reference to FIG. 27, the area blocked to antenna #1 from the top now has an alternate direct path to antenna #1 from the bottom. FIG. 18 and corresponding disclosure set forth herein describe mathematical computation of blockage area.

Further re: FIG. 27, each antenna 2510 may extend 35 mm above and 35 mm below the PCBA, under an embodiment Each antenna is served by a transceiver residing on the motherboard. Accordingly, the 35 mm high antennas are the only vertical components extending above and below the motherboard. Each antenna location on a first surface of the PCBA has a mirrored antenna location on an opposite surface of the PCBA. Each transceiver is integrated into the PCBA and is located directly between a corresponding upper and lower antenna. This transceiver placement allows the trace distance between the transceiver (including RF switch) to the top antenna to be the same be same as the trace distance between the transceiver (including RF switch) to the bottom antenna Each pair of antennas are served by a single transceiver with an RF switch. Operation of the RF switch is described below.

Under an embodiment, all RF switches are set either to top or bottom based on success of the prior communication sequence between the base unit transceivers and remote transceiver. Signal quality may be used to select top or bottom position. Signal quality may be assessed using a Standard Deviation of Channel Impulse Response Estimate (CIRE) Noise value. With a higher absolute CIRE noise figure, it is more likely that the quality of receive timestamp is poorer. High noise may mean that the real first path is irretrievably buried in the noise. Signal quality may also be assessed using a received power figure estimate. This is a calculation based on Channel impulse response power value and preamble accumulation count value. These values (CIRE and received power figure estimate) are reported by the transceivers for use in assessing signal quality.

With respect to each transceiver, a processor of the base unit implements the following operation, under an embodiment.
1. With respect to each transceiver, an RF switch choice flag is set to top.
2. With respect to each transceiver, a base unit processor or controller commands an RF switch to utilize the top antenna if the antenna choice flag is set to top or to switch and use the bottom antenna if the antenna choice flag is set to bottom.
3. The controller commands one transceiver of the three transceivers to transmit a message to the remote transceiver.
4. All transceivers listen for a response from the remote transceiver and store away the reception signal quality.
5. The controller collects the reception signal quality of responses detected by transceivers.
6. If the number of transceivers with a signal quality above a specified threshold is insufficient to resolve the remote transceiver's position to required accuracy, the controller toggles the choice flag for all transceivers, i.e. the controller sets the respective antenna choice flag to top if the antenna choice flag was set to bottom or sets the antenna choice flag to bottom if the antenna choice flag was set to top.
7. Go to step 2.

Under an embodiment, each RF switch is independently set either to top or bottom based on success of the prior communication sequence between the base unit and remote transceiver. With respect to each transceiver, a processor of the base unit implements the following operation, under an embodiment.
1. Set transceiver 1 antenna choice flag to top, transceiver 2 antenna choice flag to top, . . . through . . . transceiver n antenna choice flag to top (n=number of transceivers in base unit).
2. A processor or controller in base unit commands transceiver 1 to set its RF switch for utilizing the top antenna if the transceiver 1 antenna choice flag is set to top or to set its RF switch for utilizing the bottom antenna if the transceiver 1 antenna choice flag is set to bottom.

This step is repeated for transceiver 2/transceiver 2 antenna choice flag . . . through . . . transceiver n/transceiver n antenna choice flag (n=number of transceivers in base unit).
3. The controller commands one transceiver to transmit a message to the remote transceiver.
4. All transceivers listen for a response from the remote transceiver and store away the reception signal quality.
5. The controller collects the reception signal quality of all transceivers.
6. If the signal quality of transceiver 1 is below a specified threshold, transceiver 1 antenna choice flag is set to top if transceiver 1 antenna choice flag was set to bottom or transceiver 1 antenna choice flag is set to bottom if transceiver 1 antenna choice flag was set to top (toggle transceiver 1 antenna choice flag).
   Repeat this step for transceiver 2 signal quality/transceiver 2 antenna choice flag . . . through . . . transceiver n signal quality/transceiver n antenna choice flag (n=number of transceivers in base unit).
7. Go to step 2.

Under an embodiment, antennas 2510 only extend from an upper surface of the PCBA. As one example, each such antenna may comprise a transceiver portion extending 30 mm from the PCBA and an antenna portion extending an additional 35 mm. This embodiment eliminates the need for an RF switch.

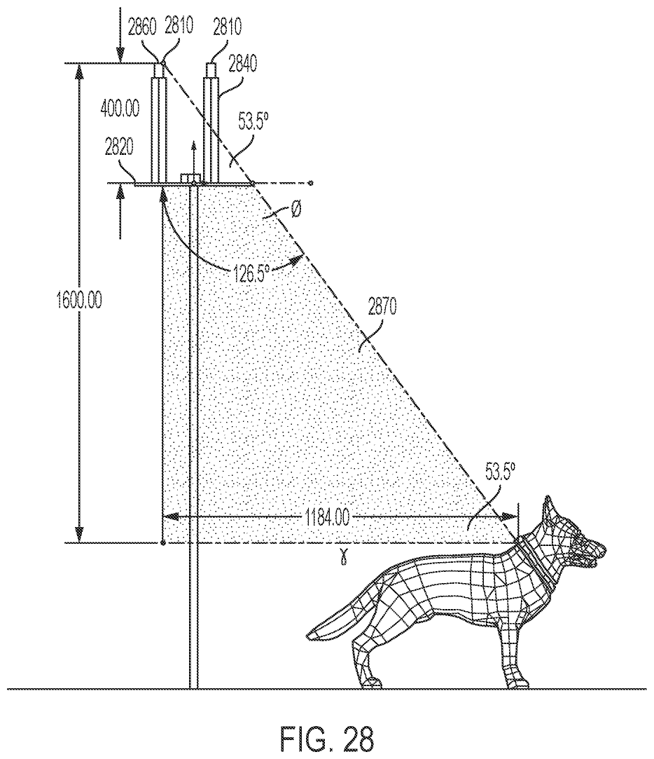

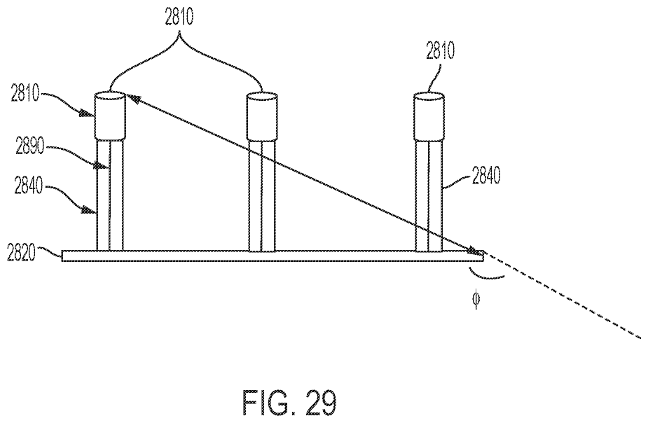

FIGS. 28 and 29 feature transceiver antennas 2810 that extend well above the SPU PCBA 2820, minimizing the angle of obstruction. The figures show antennas positioned on antenna mounts 2840 which themselves extend from the SPU PCBA. The antenna mounts provide shielded cabling 2890 which connects each antenna to a transducer incorporated into the PCBA. The shielding prevents the cabling from itself acting as an antenna.

FIG. 28 shows that antenna 2860 is positioned 400 mm above the PCBA resulting in an obstruction angle # of 126.5 degrees. FIG. 28 also shows that antenna 2860 is positioned 1600 mm above the height of collar receiver. Accordingly, distance γ is computed as

$$γ = 1600 / 53.5 = 1184.$$

Based on these calculations, FIG. 28 shows the reduced degraded coverage area 2870.

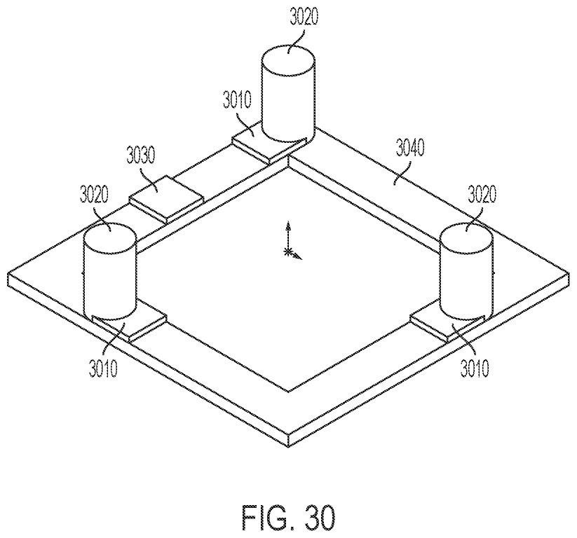

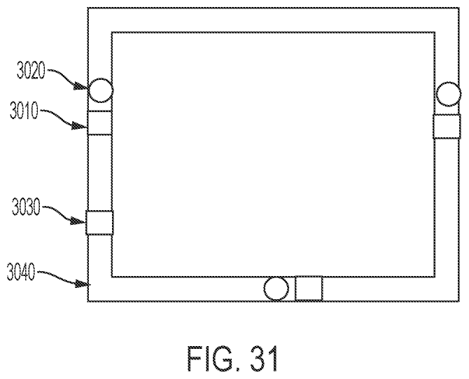

FIGS. 30 and 31 show a PCBA 3040 that is hollow. All PCBA components (including transceivers 3010, antennas 3020, and SPU 3030) and interconnections are located in a narrow strip PCBA As some trace lengths and trace length matching are critical, this is accomplished in the trace patterns. The PCBA still acts as a source of RF blockage, but the area blocked is significantly reduced due to the open area in the center which would otherwise be partially or completely blocked.

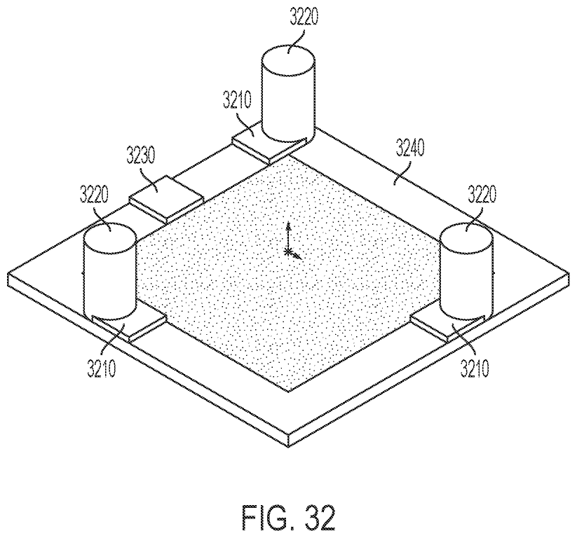

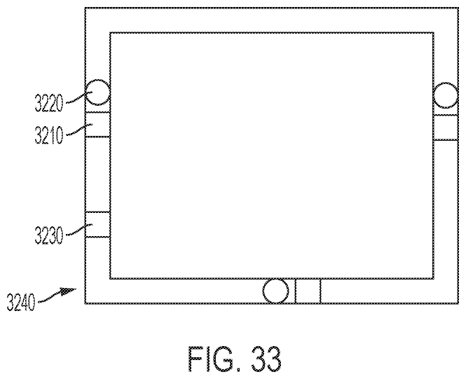

FIGS. 32 and 33 show a PCBA 3240 that is solid. However, the PCBA center is void of any planes (i.e. power, ground). The power and ground planes block RF signals. If only a minimal number of signal wires populate the center, with no planes, the RF signals will pass through the area unimpeded. While this does not totally eliminate areas of self-obstruction, it greatly reduces them. All PCBA components (including transceivers 3210, antennas 3220, and SPU 3230) are located in a narrow exterior strip of the PCBA FIG. 34 shows half of the transceivers/antennas 3410 mounted on top of the PCBA 3430 and half of the transceivers/antennas 3420 mounted on the bottom of the PCBA 3430. This allows for coverage even when the tag (i.e. collar receiver) is directly above or below the base station. As the transceiver/antenna location configurations differ on top and bottom surfaces of the PCBA, this approach requires an increase in the number of transceivers but provides complete coverage above, below, and in all directions around the base unit.

As indicated above, a single base station wireless animal location system may determine range and angular values for locating an animal worn transceiver that is communicatively coupled with the base station. The base station contains at least one transceiver and two receivers. These receivers can also be realized as transceivers.

Under one embodiment, a far field model may determine range and angular values using two way ranging and time difference of arrival computations. (It should be noted that the time difference of arrival among transceiver/antennas and/or receiver/antennas may be determined by the difference in phase of the carrier signal of an incoming signal). The far field model is based on the fact that the distance from base unit to pet transceiver is significantly farther than the distance between transceiver/receivers of the base unit. This model allows a spherical wave to be approximated by a plane FIGS. 10-15 describe implementations of the far field model. Example implementations adopt the base unit configuration of FIG. 10. The examples assume that the line between antenna 1010 and 1014 represents the reference line for angular values. It is further noted that angular values (in the examples provided above) extend from the reference line in a counter clockwise direction. Alternative embodiments may implement an alternative reference line for angular values. Further, angular values may extend from a reference line in a clockwise direction.

These example implementations described above utilize three antennas in an equilateral triangle configuration. The number of antennas can be any number greater than or equal to three, or greater than or equal to two if a physical limitation exists to block 180 degrees of the coverage of the area. Further, the configuration of antennas is not limited to any specific trigonometric configuration.

The base unit may use detected transceiver locations (i.e., locations of the animal worn transceiver) to construct a containment area, under an embodiment. A containment area may consist of one or more regions. A region is bordered by a boundary. The single base station wireless animal location system provides a pet owner with a method for defining these boundaries to the system. The most straight-forward approach to boundary definition is to walk the pet transceiver around the boundaries of each region. There are multiple methods available to initiate boundary creation learning mode:

Utilize a series of button presses on the collar containing the remote transceiver;

Utilize a series of button presses on the base unit;

Utilize a smart device interface.

If a series of button presses on the base is utilized, either a delay is utilized to allow users to position themselves at the starting position or a second person may press the buttons while the first person is waiting at the starting position of the boundary.

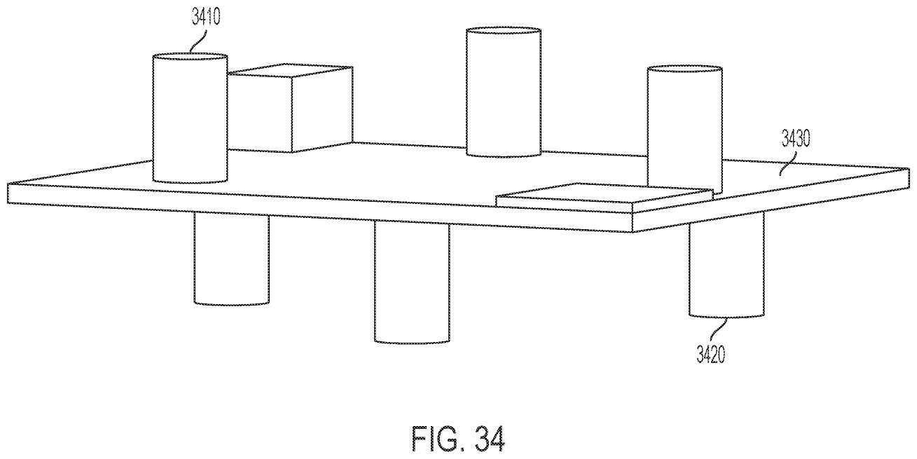

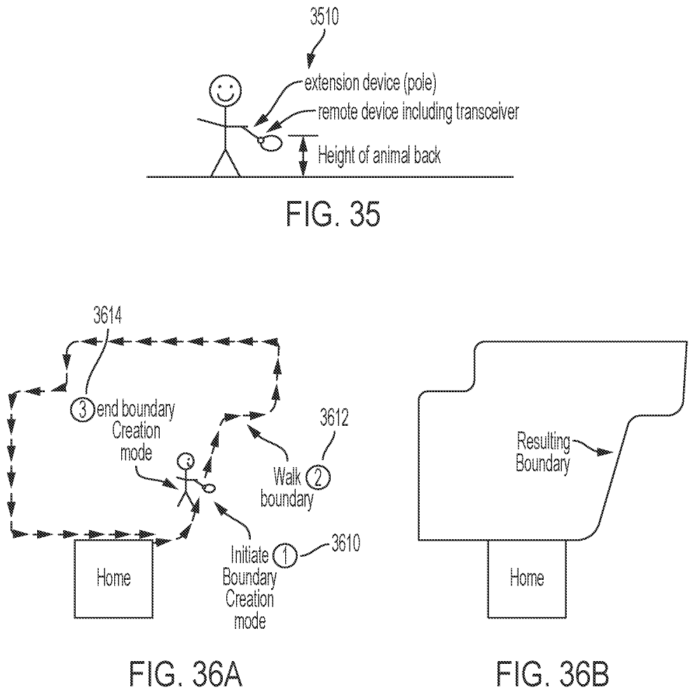

Once learning mode is initiated, the collar containing the pet transceiver is typically held at a height approximating the height of the animal's back. Maintaining this height, the user walks the collar around the region to identify the boundaries to the system. The remote transceiver may be mounted to an extension device during the path formation. As seen in FIG. 35, the extension device 3510 is simply a tool for maintaining a consistent location of the transceiver at the height of a dog during path formation. When the user returns to the starting point, the region is complete resulting in a closed region. Alternatively, the end of the region creation can be initiated at any position along the boundary if an open region is desired (and as further described below). The boundaries of the region may be stored in the collar, stored in the base station, or stored on an external device.

Boundary determination is used to create a region for pet management. The borders of the region are referred to as boundaries. Regions may correspond to designated functions. For example, the region may be a containment region serving to keep the pet contained. The region may be a keep-out region serving to keep the pet away from objects or areas. The region may be a reporting region serving to make the owner aware the pet entered or exited a defined region.

Functions can be a single event that occurs on the crossing of a boundary, either into a region or out of a region. One example of this is the initiation of a message to a pet owner of a pet leaving a reporting region as the pet crosses the boundary, exiting the reporting region.

Functions can occur constantly or intermittently based on position in a region or out of a region. One example of this is the continued static correction of a pet as long as position reports indicate the pet is outside of the containment region.

Every location on the boundary has a positional coordinate relative to the base unit. The coordinate system is shared by the base unit and collar, under an embodiment. The base unit is typically, but not limited to, a position designated as the origin of the coordinate system, more specifically the cartesian coordinate system. Under an embodiment, the positional coordinates comprise angular and range values as described above. Angular and range values may be converted into cartesian coordinates as also described above. When a base unit detects polar coordinates of a remote transceiver, the corresponding cartesian coordinates are also known.

As a first step in boundary creation, the user moves to a position on the desired boundary while holding the collar containing the remote transceiver (FIG. 36A, 3610). An extension stick may be utilized to position the collar as close to the height of the collar when it is on the animal's neck. Boundary creation is then initiated, typically via button press on the collar or base unit, or via smart phone interface. The base unit performs a communication transaction between itself and the collar containing the remote transceiver. The communication transaction allows the base unit to determine the position of the collar within the coordinate system, more specifically the cartesian coordinate system. Under one embodiment cartesian coordinate data is represented as millimeters. The position is stored in the memory of the base unit. The position may alternatively be sent from the base unit to the collar for storage on the collar.

The user begins to walk along the desired boundary location while holding the collar (FIG. 36A, 3612). After a designated period of time, the base unit performs another communication transaction between itself and the collar containing the remote transceiver, allowing another position determination to be performed. The designated period of time is dependent on the desired precision of the boundary. A typical period of time is 100 mS (frequency of 10 Hz). A shorter period of time increases the boundary precision while a longer period of time decreases the boundary precision. The new position is stored in the memory of the base unit, typically as cartesian coordinates. The new position may alternatively be sent from the base unit to the collar for storage on the collar. The process of determining and storing the position of the collar is repeated as the user walks along the boundary until the region definition is complete (FIG. 36A, 3614). The process is ended via button press (on collar or base unit) or smart phone interface. Under this embodiment, a user terminates boundary creation. Under an alternative embodiment, boundary creation is automatically terminated when the initial position determination is repeated (return to the starting location). This embodiment necessarily results in a closed region.

If ended with a button press or smart phone interface, the last and first positions are connected, closing the boundary and forming a region if a closed region is desired. If automatic region closure is desired, a tolerance vector must be defined which indicates whether the last resolved position report is close enough to the starting position to determine region closure.

For example, a tolerance of 500 mm is defined. If the boundary is walked and the position values determined by the system indicate the user has returned to a position within 500 mm of the starting position, the region is closed and boundary creation ends. For the example of a 500 mm tolerance, if the starting point for a boundary is (4650 mm, 10430 mm) and the system calculates a new position of (4410 mm, 11000 mm) the boundary creation process would continue as the distance between the points is 620 mm. If the system calculates a new position of (4530 mm, 10640 mm) the boundary creation process would end as the distance between the points is 240 (less than 500 mm). The points (4650, 10430) and (4530, 10640) would be joined and the closed region defined.

FIG. 36B shows a resulting boundary.

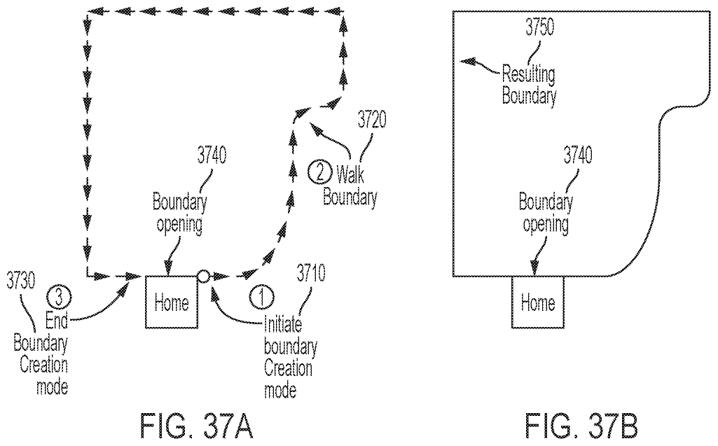

FIGS. 37A and 37B show an open boundary. As described above, a user defines the boundary by walking the collar around the desired region. As seen in the figures, the user initiates automatic boundary determination at location 3710, walks 3720 around the desired region, and terminates the boundary determination at location 3730. The resulting region 3750 includes an “open” line segment 3740 between location 3730 and location 3710. Note that the open line segment 3740 is immediately adjacent a front of a home. If the pet leaves the region and enters the house, the pet is safe. Accordingly, crossing the boundary under this circumstance is not considered a boundary crossing.

A boundary that includes an open segment would need to be initiated and concluded with a button press or smart phone interface as proximity of the start and end positions would not necessarily be in close proximity to each other.

Typically, the first position and last position are joined, allowing the line to form a closed region. This region can be stored, typically as a series of positional data points, in the base unit or collar unit. While discrete data points are stored, the incremental positions along the line formed by any two sequential data points may also be determined. In two dimensions, the slope intercept form of writing the equation of a straight line can be utilized. The equation is y=mx+b, where x and y represent x and y positions along the line, m represents the slope of the line in two dimensions, and b represents an initial y position.

### Example

$$Stored position 1 ( x , y ) = ( 2000 , 3000 )$$

$$Stored position 2 ( x , y ) = ( 6000 , 5000 )$$

$$Determine slope ( m ) = ( y 2 - y 1 ) / ( x 2 - x 1 ) = ( 5 \; 000 - 300 \; 0 ) / ( 6000 - 2000 ) = 0.5$$

To find any position along the line, the equation y=(0.5)x+3000 can now be used,

bounded by x's in the 2000 to 6000 range and y's in the 3000 to 5000 range.

Under one embodiment, a user may receive feedback on the quality of the communication transactions between the base unit and the collar containing the remote transceiver as the user walks the boundary. The feedback may be indicative of every communication transaction between the base unit and collar transceiver or an averaged value over a period of time. For example, if a base unit and collar are communicating at 10 Hz, the feedback may indicate the quality of every transaction, or some averaged value, for example averaged over every 5 transactions, yielding one result every %2 second. The feedback may be indicated via a visual or audible indicator on the collar, base unit, or smart phone interface. This process can ensure that all positions along the desired boundary have sufficient signal quality to reliably detect the position of the collar. The quality of the communication transaction can be based on signal strength, signal-to-noise levels, or more complex assessment as allowed by the specific communication protocol being employed by the base unit and collar transceiver. One example would be ultra-wideband communication. The quality of an ultra-wideband signal can be assessed utilizing metrics of the Channel Impulse Response (CIR). The processor linked to the transceiver (i.e., collar or transceiver processor) uses data provided by the receiver portion of the transceiver via an Application Programming Interface (API) to analyze the CIR noise and power levels of the overall signal and first path signals. This received signal CIR analysis may be converted to a quality score of the received signal. The base unit processor performs the analysis when receiving remote transceiver transmissions, and the remote transceiver processor performs the analysis when receiving base unit transmissions. For the highest level of position determination integrity, the CIR analysis from both the base unit and remote transceiver unit should show a high quality level. The remote transceiver processor may report its quality scores to the base unit, or the base unit processor may provide its quality scores to the remote transceiver processor. Under one embodiment, either the base unit processor or the remote transceiver processor determines whether the signal quality of transmissions received by the base unit and remote transceiver are sufficiently high. Under an alternative embodiment, feedback may be provided based on remote transceiver transmissions alone or base unit transmissions alone.

This embodiment implementing a signal quality feedback signal may be utilized in conjunction with automatic or manual boundary creation. If utilized in conjunction with automatic boundary creation, the feedback may simply be provided to a user as the user walks the collar along a desired boundary path. In other words, the feedback simply provides a user information as to the integrity of location detection. If the feedback is consistently poor, base unit is unable to reliably detect and store positions of the collar in creation of a boundary. Under an alternative embodiment, the base unit may use signal quality assessment to filter detected locations. Continuing with the example above, if a base unit and collar are communicating at 10 Hz, the feedback may indicate the quality of every transaction. If the feedback indicates poor signal quality, then the base unit may discard the corresponding location detection. If the averaged feedback over five transaction is poor, the base unit may discard all five transactions. This signal quality assessment may represent a separate phase that precedes the actual boundary creation phase. This separate phase allows the user to preview the signal quality of the positions along the preferred boundary before an automatic boundary creation phase occurs.

Under one embodiment, a user may manually determine the frequency of position determination. Under this approach, a user begins to walk along the desired boundary location while holding the collar (FIG. 36A, 3612). The base unit performs communication transactions between itself and the collar containing the remote transceiver, allowing another position determination to be performed. As indicated above a typical period of time between position determinations is 100 mS (frequency of 10 Hz). However, boundary positions are only stored into memory upon initiation by the user via a button press on the collar, a button press on the base unit, or interaction with a smart phone interface. This embodiment can be utilized to create a closed or open boundary. If an open boundary is desired, the button or smart phone interface must differentiate the last position set as the final boundary location. Another implementation is to utilize the smart phone interface to query whether the first and last boundary positions should be connected.

The signal quality feedback may occur in conjunction with manual boundary creation. If utilized in conjunction with manual boundary creation, the feedback may simply be provided to a user as the user walks the collar along a desired boundary path. In other words, the feedback simply provides a user information as to the integrity of location detection. If the feedback is positive, a user may then manually select a boundary position with confidence. This signal quality assessment may represent a separate phase that precedes the actual boundary creation phase. This separate phase allows the user to preview the signal quality of the positions along the preferred boundary before a manual boundary creation phase occurs. This allows a user to test out a path for signal quality before committing the path into memory.

This manual mode also creates a region with fewer positional data points, making the in/out of region math much faster. The boundary positions are stored in the memory of the base unit or collar, typically as cartesian coordinates. If a square or rectangular region is desired, the system may only have to store 4 positional data points. If button presses are utilized to enter in each position, either a different button could be utilized to differentiate the incremental positions from the start and stop positions or a single button can be utilized with a distinctive pattern used to differentiate start/stops from the incremental positions. For example, a single button push could be used to start a boundary creation, a single button press could be used to enter each position along the boundary, and a double-press of the button could be used to end boundary creation. If automatic boundary closure is desired, the double-press may not be required as proximity to the starting position would be sufficient to end the boundary creation.

Once the collar is put into operational mode, the process of determining the position of the collar within the coordinate system is continually performed by the base unit. If a region was stored within the base unit, the base unit determines whether each position report is within the region or outside the region. Based on the result the base unit may perform a programmed function. The programmed function may be the transmission of the in/out of region determination result to the collar, allowing the collar to determine a function based on the result. The programmed function may be the transmission of an action to the collar such as “stimulate the pet with a static correction” if the pet is outside of a containment region.

The programmed function may be the transmission of a message to the pet owner reporting the position of the pet relative to a boundary.

Alternatively, if a region was stored within the collar, the base unit transmits the last determined position to the collar. The collar then determines whether each position report is within the region or outside the region. Based on the result the collar may perform a programmed function. The programmed function may be “stimulate the pet with a static correction” if the pet is outside of a containment region.

The process of determining whether each positional report is within a region or outside a region can be performed using one of many known algorithms. One such know algorithm is ray casting. Ray casting determines whether a given position is inside or outside of a polygon. Since the region is created by connecting many positional data points, the region can be considered a polygon. The ray casting algorithm chooses a point outside of the region. A virtual ray is drawn from the positional report to the point outside of the region. A count of region boundary crossings is performed on the virtual ray. If the number of crossings is even, the position is outside of the boundary. If the number of crossings is odd, the position is inside the boundary.

The ray casting algorithm works by breaking the polygon down into the line segments (L₁ . . . Lₙ; n=number of line segments in polygon) that make up the polygon. A positional point is picked well outside the boundary. A line (L_{ref}) is drawn from the current position to the positional point well outside of the boundary. L_{ref} is checked against each line segment L₁ . . . Lₙ for intersection.

As an example, to compare L_{ref} to the first line segment of the polygon, L₁:

L_{ref} is defined by the endpoints: (x₁, y₁) and (x₂, y₂)

L₁ is defined by the endpoints (x₃, y₃) and (x₄, y₄)

1) denominator=((x₁-x₂)*(y₃-y₄))−((y₁-y₂)*(x₃-x₄))

2) if denominator=0, the lines do not intersect [end of calculations]

3) calculate t and u:

$$t = ( ( {x}_{1} - {x}_{3} ) * ( {y}_{3} - {y}_{4} ) ) - ( ( {y}_{1} - {y}_{3} ) * ( {x}_{3} - {x}_{4} ) ) / denominator$$

$$u = ( ( {x}_{1} - {x}_{3} ) * ( {y}_{1} - {y}_{2} ) ) - ( ( {y}_{1} - {y}_{3} ) * ( {x}_{1} - {x}_{3} ) ) / denominator$$

4) if 0≤t≤1 and 0≤u≤1 then the lines intersect, otherwise they do not intersect.

If an open region is desired, a further step must be implemented where positional reports are analyzed to see if they cross the line formed by the starting and ending points of the region (region opening). If the positional reports indicate a crossing of this polygon line segment, the collar is determined to be within the region.

A more advanced layer of software can be implemented on top of the position versus region layer. This layer can make decisions based on the speed and distance relative to the boundary. For example, if a collar's position and speed as it approaches a boundary make it extremely likely that a boundary crossing will occur, the application can be proactive and initiate a static correction to the pet at a distance prior to the actual boundary to further ensure the safety of the pet.

A device is described herein comprising under an embodiment a base unit including at least three transceivers, wherein the at least three transceivers are communicatively coupled with at least one processor of the base unit. The at least one processor and the at least three transceivers are configured to determine locations of a transceiver remote to the base unit, wherein the location determinations comprise a series of transceiver locations along a boundary path, wherein the series of location determinations define a boundary region, wherein each location determination comprises a first transceiver of the at least three transceivers transmitting a communication to the transceiver, the at least three transceivers receiving a response from the transceiver, wherein the response comprises a return communication, the at least one processor using information of the return communication to determine a first time of flight, wherein the first time of flight comprises the time elapsed between transmission of the return communication and the receiving of the return communication by the first transceiver, the at least one processor using the first time of flight to determine a first distance between the first transceiver and the transceiver, the at least one processor determining a time difference of arrival among the at least three transceivers receiving the return communication, and the at least one processor determining an angular value using information of the time difference of arrival, the relative positioning of the at least three transceivers, and signal transmission speed of the return communication, wherein the angular value and the first distance determine the location of the transceiver.

The at least three transceivers comprise three transceivers defining vertices of a triangle, wherein the three transceivers include the first transceiver, under an embodiment.

The triangle comprises an equilateral triangle, under an embodiment.

Sides of the equilateral triangle are equal to or less than 20 cm, under an embodiment.

The angular value comprises an angle between a reference direction and an axis, under an embodiment.

The reference direction comprises a fixed unit vector originating at a vertex of the triangle and extending along a side of the triangle, under an embodiment.

The vertices of the triangle define a plane, wherein a plurality of quadrants partitions the plane into radial segments extending from the base unit, under an embodiment.

The information of the time difference of arrival comprises an order of reception between an initial two transceivers of the three transceivers receiving the return communication, under an embodiment.

The determining the angular value includes using the order of reception between an initial two transceivers of the three transceivers to locate the transceiver in a quadrant of the plurality of quadrants, under an embodiment.

The determining the angular value includes constructing a right triangle, wherein the initial two antennas comprise vertices of the right triangle, wherein a first side of the right triangle is oriented in a direction of the transceiver in the quadrant, wherein a second side of the right triangle comprises a line between the initial two antennas, under an embodiment.

The determining the angular value includes determining a first length of the first side using the signal transmission speed and the time difference of arrival between the initial two antennas receiving the return communication, under an embodiment.

A second length comprises a length of the second side, under an embodiment, under an embodiment.

The determining the angular value comprises determining the angular value using the first length, the second length, and information of the quadrant, under an embodiment.

The base unit comprises a clock that synchronizes communications of the at least three transceivers, under an embodiment.

The at least one processor uses the clock to determine the time difference of arrival, under an embodiment.

The at least one processor determines the time difference of arrival using a difference in phase of a carrier signal of the return communication among the at least three transceivers, under an embodiment.

The boundary region comprises line segments connecting the location determinations, under an embodiment.

The at least one processor is configured to perform additional location determinations subsequent to definition of the boundary region, under an embodiment.

The at least one processor is configured to determine a location of the transceiver relative to the boundary region using the additional location determinations, under an embodiment.

The at least one processor is configured to transmit the location determinations and the additional location determinations to the transceiver, wherein a remote collar device includes the transceiver, wherein the transceiver is communicatively coupled with one or more processors of the remote collar device, under an embodiment.

The one or more processors of the collar device are configured to determine a location of the transceiver relative to the boundary region using the additional location determinations, under an embodiment.

The at least one processor is configured to initiate location determinations upon receiving at least one instruction, under an embodiment.

The at least one instruction comprises an instruction to automatically perform location determinations at a frequency, under an embodiment.

The at least one instruction comprises a series of intermittent instructions to perform a location determination, under an embodiment.

The at least one processor is configured to cease the location determinations when a distance between a first location in the series and a subsequent location in the series is less than a first value, under an embodiment.

The at least one processor is configured to cease the location determinations when the at least one processor receives a stop communication, under an embodiment.

The at least one processor is configured to assess signal quality of communications between the base unit and the transceiver, under an embodiment.

The at least one processor is configured to assess the signal quality of communications corresponding to each location determination, under an embodiment.

The at least one processor is configured to average the signal quality of communications across a number of location determinations, under an embodiment.

The at least one processor is configured to discard one or more location determinations when the signal quality is poor, under an embodiment.

Computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The location based wireless pet containment system using single base unit can be a component of a single system, multiple systems, and/or geographically separate systems. The location based wireless pet containment system using single base unit can also be a subcomponent or subsystem of a single system, multiple systems, and/or geographically separate systems. The components of the location based wireless pet containment system using single base unit can be coupled to one or more other components (not shown) of a host system or a system coupled to the host system.

One or more components of the location based wireless pet containment system using single base unit and/or a corresponding interface, system or application to which the location based wireless pet containment system using single base unit is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that include the location based wireless pet containment system using single base unit can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the location based wireless pet containment system using single base unit and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the location based wireless pet containment system using single base unit and corresponding systems and methods include: microcontrollers with memory (such as electronically erasable programmable read only memory (EEPROM)), embedded microprocessors, firmware, software, etc. Furthermore, aspects of the location based wireless pet containment system using single base unit and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the location based wireless pet containment system using single base unit is not intended to be exhaustive or to limit the systems and methods to the precise forms disclosed. While specific embodiments of, and examples for, the location based wireless pet containment system using single base unit and corresponding systems and methods are described herein for illustrative purposes, various equivalent modifications are possible within the scope of the systems and methods, as those skilled in the relevant art will recognize. The teachings of the location based wireless pet containment system using single base unit and corresponding systems and methods provided herein can be applied to other systems and methods, not only for the systems and methods described above.

The elements and acts of the various embodiments described above can be combined to provide further embodiments. These and other changes can be made to the location based wireless pet containment system using single base unit and corresponding systems and methods in light of the above detailed description.

What is claimed is:

1. A device comprising,
a base unit including at least three transceivers, wherein the at least three transceivers are communicatively coupled with at least one processor of the base unit;
the at least one processor and the at least three transceivers configured to determine locations of a transceiver remote to the base unit, wherein the location determinations comprise a series of transceiver locations along a boundary path, wherein the series of location determinations define a boundary region, wherein each location determination comprises,
a first transceiver of the at least three transceivers transmitting a communication to the transceiver,
the at least three transceivers receiving a response from the transceiver, wherein the response comprises a return communication,
the at least one processor using information of the return communication to determine a first time of flight, wherein the first time of flight comprises the time elapsed between transmission of the return communication and the receiving of the return communication by the first transceiver,
the at least one processor using the first time of flight to determine a first distance between the first transceiver and the transceiver,
the at least one processor determining a time difference of arrival among the at least three transceivers receiving the return communication, and
the at least one processor determining an angular value using information of the time difference of arrival, the relative positioning of the at least three transceivers, and signal transmission speed of the return communication, wherein the angular value and the first distance determine the location of the transceiver.

2. The device of claim 1, wherein the at least three transceivers comprise three transceivers defining vertices of a triangle, wherein the three transceivers include the first transceiver.

3. The device of claim 2, wherein the triangle comprises an equilateral triangle.

4. The device of claim 3, wherein sides of the equilateral triangle are equal to or less than 20 cm.

5. The device of claim 2, wherein the angular value comprises an angle between a reference direction and an axis.

6. The device of claim 5, wherein the reference direction comprises a fixed unit vector originating at a vertex of the triangle and extending along a side of the triangle.

7. The device of claim 6, wherein the vertices of the triangle define a plane, wherein a plurality of quadrants partitions the plane into radial segments extending from the base unit.

8. The device of claim 7, wherein the information of the time difference of arrival comprises an order of reception between an initial two transceivers of the three transceivers receiving the return communication.

9. The device of claim 8, the determining the angular value including using the order of reception between an initial two transceivers of the three transceivers to locate the transceiver in a quadrant of the plurality of quadrants.

10. The device of claim 9, the determining the angular value including constructing a right triangle, wherein the initial two antennas comprise vertices of the right triangle, wherein a first side of the right triangle is oriented in a direction of the transceiver in the quadrant, wherein a second side of the right triangle comprises a line between the initial two antennas.

11. The device of claim 10, the determining the angular value including determining a first length of the first side using the signal transmission speed and the time difference of arrival between the initial two antennas receiving the return communication.

12. The device of claim 11, wherein a second length comprises a length of the second side.

13. The device of claim 12, the determining the angular value comprising determining the angular value using the first length, the second length, and information of the quadrant.

14. The device of claim 1, wherein the base unit comprises a clock that synchronizes communications of the at least three transceivers.

15. The device of claim 14, the at least one processor using the clock to determine the time difference of arrival.

16. The device of claim 1, the at least one processor determining the time difference of arrival using a difference in phase of a carrier signal of the return communication among the at least three transceivers.

17. The device of claim 1, wherein the boundary region comprises line segments connecting the location determinations.

18. The device of claim 17, wherein the at least one processor is configured to perform additional location determinations subsequent to definition of the boundary region.

19. The device of claim 18, wherein the at least one processor is configured to determine a location of the transceiver relative to the boundary region using the additional location determinations.

20. The device of claim 17, wherein the at least one processor is configured to transmit the location determinations and the additional location determinations to the transceiver, wherein a remote collar device includes the transceiver, wherein the transceiver is communicatively coupled with one or more processors of the remote collar device.

21. The device of claim 20, wherein the one or more processors of the collar device are configured to determine a location of the transceiver relative to the boundary region using the additional location determinations.

22. The device of claim 1, the at least one processor configured to initiate location determinations upon receiving at least one instruction.

23. The device of claim 22, wherein the at least one instruction comprises an instruction to automatically perform location determinations at a frequency.

24. The device of claim 22, wherein the at least one instruction comprises a series of intermittent instructions to perform a location determination.

25. The device of claim 22, the at least one processor configured to cease the location determinations when a distance between a first location in the series and a subsequent location in the series is less than a first value.

26. The device of claim 22, the at least one processor configured to cease the location determinations when the at least one processor receives a stop communication.

27. The device of claim 1, wherein the at least one processor is configured to assess signal quality of communications between the base unit and the transceiver.

28. The device of claim 27, wherein the at least one processor is configured to assess the signal quality of communications corresponding to each location determination.

29. The device of claim 28, wherein the at least one processor is configured to average the signal quality of communications across a number of location determinations.

30. The device of claim 29, wherein the at least one processor is configured to discards one or more location determinations when the signal quality is poor.
